(19) United States
(12) Patent Application Publication
(10) Pub. No.: US 2022/0094900 A1
(43) Pub. Date: Mar. 24, 2022

(54) MEDIA ALBUM FOR DIGITAL MEDIA

(71) Applicant: INNOVATIVE ALBUMS, Norboro (CA)

(72) Inventors: Katelyn DALEY, Norboro (CA); Patrick DALEY, Norboro (CA)

(21) Appl. No.: 17/478,495

(22) Filed: Sep. 17, 2021

Related U.S. Application Data
(60) Provisional application No. 63/081,460, filed on Sep. 22, 2020.

(51) Int. Cl. H04N 9/87; G06F 3/14; G06F 21/31

(52) U.S. Cl. CPC H04N 9/87; H04R 1/028; G06F 21/31; G06F 3/14

(57) ABSTRACT

A photo album including a front cover and a back cover. The front cover and the back cover bind a plurality of pages configured to have printed photographs displayed thereon. The photo album includes a video display incorporated into a surface of the front cover, the back cover, or one of the plurality of pages. The photo album also includes an electronic module coupled to the video display. The electronic module includes a mass storage storing a video file therein and is coupled to a user interface.

### CROSS-REFERENCE TO RELATED APPLICATIONS

This application claims the benefit of priority to U.S. patent application Ser. No. 63/081,460 entitled “MEDIA ALBUM FOR DIGITAL, MEDIA” filed Sep. 22, 2020, hereby incorporated by reference in its entirety.

### FIELD OF THE INVENTION

The present invention pertains to multi-media photo albums, and in particular to a multi-media photo album capable of displaying both printed photos and digital media.

### BACKGROUND

Traditional photo albums in many forms exist to store, display, and view printed photographs. Typically, in the form of a bound volume, pages may be fixes or removable, and in some cases, additional pages may be added. Photos may be held to the pages and cover of photo albums using a variety of means.

In the present day, most photographs are taken using digital cameras which store the image in digital files. Digital photographs, together with other forms of digital media such as video and audio recordings, are often used to capture important life events such as a wedding, graduation, birthday, family holidays, or to remember a loved one. Much of the digital media that is captured by consumers today is done through the use of a cellular phone, or smart phone, that can take photos, record video, and record audio.

Digital media may be stored and transmitted using techniques common to all digital files and may be stored on solid-state memory, copied to a computer, uploaded to cloud computing storage, or shared over social media. However, consumers often with to organize and display their photographs using a traditional photo album format as it provides a tangible, permanent copy of the photograph that is easy to share and view in social settings. A traditional photo album is also a popular gift to memorialize special events.

Printed photographs also have the advantage of permanence since they cannot be deleted. as a computer file may be. They cannot be lost when a cellular phone, digital camera, or memory card is damages, and you cannot lose access to them when a 3^{rd} party social media or cloud storage provider shuts down or you are unable to access your account for any reason.

Though traditional photo albums are well suited to display printed photographs, they are unable to display other digital media, such as video or audio recording. Therefore, there exists a need for an innovative media album capable of displaying and storing both printed photographs and digital media. Such a media album may also store digital media files to allow a consumer a greater degree of confidence that they will be able to access the files in the future.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide an apparatus and method that provides storage for printed photographs and digital media and allows for a user to manage, display, and present these photographs and digital media in an intuitive and pleasing manner.

In accordance with embodiments of the present invention, there is provided a photo album including a front cover and a back cover binding a plurality of pages configured to have printed photographs mounted displayed thereon. A video display is incorporated into a surface of the front cover, the back cover, or one of the plurality of pages. An electronic module is coupled to the video display and includes a mass storage storing a video file therein. A user is interface coupled to the electronic module.

In a further embodiment, the photo album includes a sensor coupled to the electronic module, wherein an output of the sensor causes the video file to be displayed on the video display.

In an embodiment, the sensor detects when the video display is exposed for viewing.

In an embodiment, the video display is disposed on an inner surface of the front cover and the front cover is configurable in a position that exposes the video display for viewing.

In an embodiment, the video file is displayed on the video display based on a criteria defined through the user interface.

In an embodiment, the electronic module includes a wireless network interface and the user interface is accessed using an app.

In an embodiment, the electronic module includes a wireless network interface and the video file is displayed on an external video device.

In an embodiment, the user interface requires a user to authenticate before allowing access to the user interface.

In a further embodiment, the photo album includes a second video display and the user interface allows the video file to be displayed on the video display or the second video display. In embodiments, second video display is disposed on one of the plurality of pages.

In accordance with embodiments of the present invention, there is provided a method for a photo album to display digital and printed media. The method includes receiving a video file into a mass storage of the photo album. Receiving an input from a user interface selecting the digital media file where the input selects a criteria to start. a playback of the video file. Detecting, by an electronic module, the criteria, and starting the playback of the video file on a video display. The video display may be incorporated into a surface of a front cover, a back cover, or one of a plurality of pages of the photo album. The electronic module is coupled to the video display and the user interface.

Further embodiment includes, receiving a second criteria through the user interface, and stopping the playback of the video file in response to the second criteria being met.

In embodiment, the electronic module includes a wireless network interface and the user interface is accessed over the wireless network interface.

In embodiments, the electronic module includes a wireless network interface and the video file is displayed on an external video device using the wireless network interface.

Further embodiments include, authenticating a user prior to receiving the input over the user interface.

Further embodiments include starting, by the electronic module, the playback of the video file on a second video display where the second video display being selected through the user interface.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a front-side view of an album with a video display disposed at a viewing angle, according to an embodiment.

FIG. 2 illustrates a front view of an album with a video display disposed at a viewing angle, according to an embodiment.

FIG. 3 illustrates a side view of the album with a video display disposed at a viewing angle, according to an embodiment.

FIG. 4 illustrates a side view of an album in a closed position, according to an embodiment,

Fig, 5 illustrates a front view an album in the closed position, according to an embodiment.

FIG. 6 illustrates an opposing side view of the album with a video display disposed at a viewing angle, according to an embodiment.

FIG. 7 illustrates an opposing side view of an album in a closed position, according to an embodiment.

FIG. 8 illustrates a rear view of an album in a closed position, according to an embodiment.

FIG. 9 illustrates a top view of an album in a closed position, according to an embodiment,

FIG. 10 illustrates a bottom view of an album in a closed position, according to an embodiment,

FIG. 11 is a schematic diagram of an electronic device that may perform any or all of operations of the above methods and features explicitly or implicitly described herein, according to different embodiments of the present invention.

It will be noted that throughout the appended drawings, like features are identified by ike reference numerals.

### DETAILED DESCRIPTION

As used herein, the term “about” should be read as including variation from the nominal value, for example, a +1-10% variation from the nominal value. It is to be understood that such a variation is always included in a given value provided herein, whether or not it is specifically referred to.

Embodiments of the present invention relate to a media album that may be used for the storage and presentation of printed photographs as well as digitally printed photos and digital media that allows for a user to manage, display, and view photographs and digital media stored therein. As used herein, media album refers has the form of a hard or soft covered book as is known in the art. It may also refer to other types of printed material such as a textbook, instruction manual, or any other type of printed material that may combine printed photographs and digital media. As used herein, digital media includes video or audio files that include digital video recordings, with or without an audio component, digital audio files, and still digital photographs.

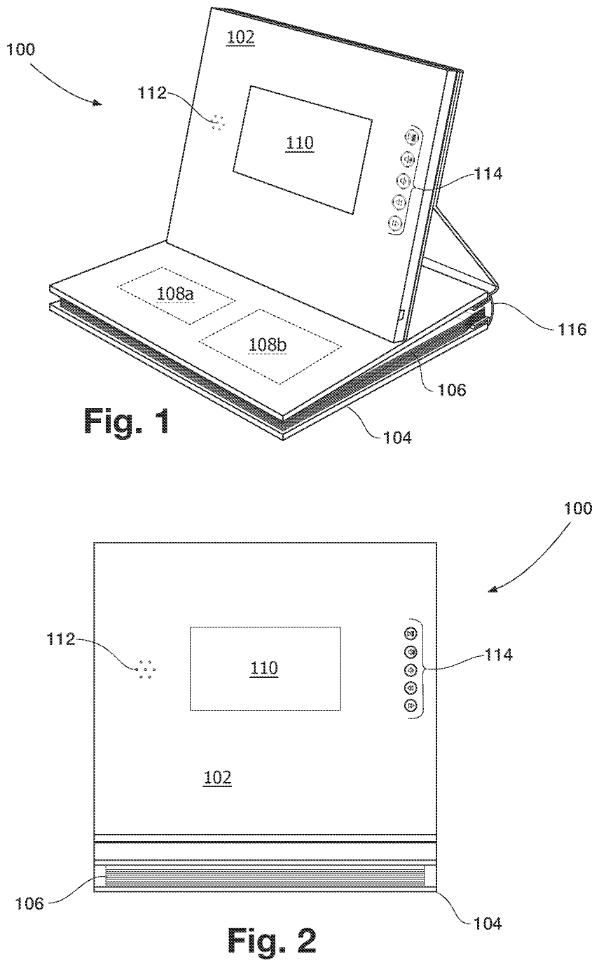

FIG. 1 illustrates media album 100 according to an embodiment. It includes a front cover 102 and back cover 104 that bind therein, a number of pages 106. A spine may be included connecting the front cover 102 and the back cover 106. The front cover 102, back cover 104, and pages 106 may be of any paper, plastic, composite material as is known in the art. Pages 106 and either cover can have printed photographs such as 108a and 108b mounted thereon using any variety of known means.

Media album cover 102 includes one or more digital media devices such as video display 110 and speakers 112. Video display 110 may be provided in any number of locations on the inside and outside of media album 100. In FIG. 1 video display 110 is shown in the inside of cover 102 which provides protection to the display and is only visible when the cover 102 is in an open position, as illustrated. In other cases, video display 110 may be located on the outside of cover 102, on the inside or outside of back 104, on a spine 116 of the media album, or on any of the pages 106 of the media album. Multiple video displays 110 may be located in different locations of media album 100. The video display itself may take the form of a flat panel display using thin-film transistors, OLED, or flexible display technology.

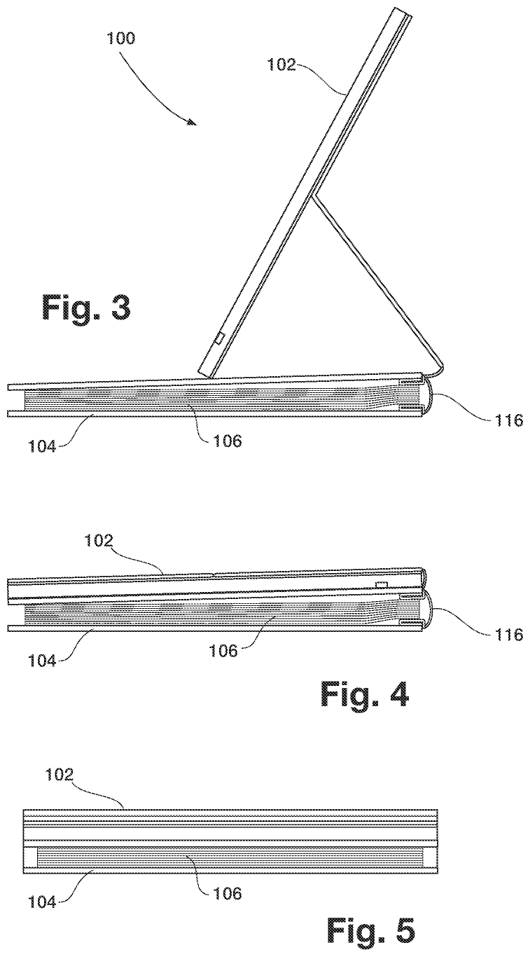

With reference to FIG. 2 and FIG. 3, front cover 102 may be propped in an open position to allow for optimal viewing height and be used hands free. An outer surface of cover 102 may be creased to fold along a horizontal allowing an inner surface of cover 102, including video display 110, to be supported at a viewing angle.

Speakers 112 may be integrated into video display 110 or may be located in the front cover 102, back cover 104, spine 116, or other location of media album 100. In embodiments, speakers 112 may be located in or on the same surface as video display 110. For example, if video display 110 is located on an inner side of cover 102, speakers 112 may be located adjacent to video display 110 on the same inner side of cover 102.

A user interface 114 is provided to control operation of the media album 100. This includes loading digital media, organizing it, displaying it on one or move video displays 110, sending and receiving digital media over a connected network, connecting to external controllers and cell phone apps, deleting digital media, etc. User interface 114 may take the form of mechanical buttons or switches, resistive or capacitive touch controls, etc. and may be integrated into the video display 110 or provided elsewhere on front cover 102, back cover 106, spine, or as part of a page 106, which may be a dedicated page for controls. User interface may also take the form of a remote control that may be separate from the media album 100 or mounted therein. User interface 114 includes required hardware and software to control input and output to the user interface.

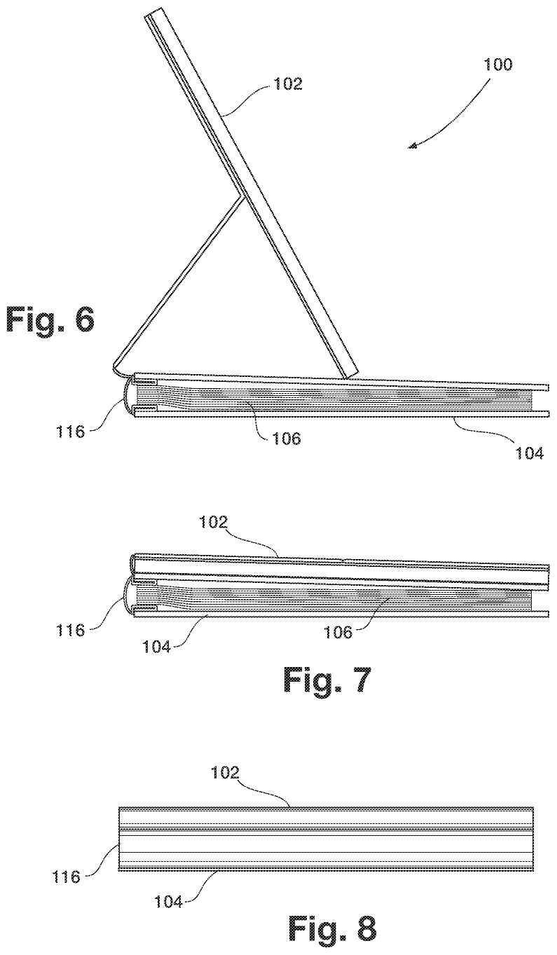

FIG. 4 illustrates a side view of media album 100 in the closed position. FIG. 5 illustrates a front view media album 100 in the closed position. FIG. 6 illustrates an opposing side view of media album 100 with top cover 102 in the open position to allow video display 110 to be viewed. FIG. 7 illustrates an opposing side view of media album 100 in a closed position.

FIG. 8 illustrates a rear view of media album 100 in a closed position with spine 116 visible. In embodiments, a video display may be installed in a portion of spine 116 to enable viewing of a video file when the media album 100 is placed on a bookshelf in a vertical or horizontal position. During playback, media album 100 may sense its orientation and automatically rotate video playback from a portrait to landscape orientation, of from a landscape to portrait orientation so that the video is properly oriented for viewing.

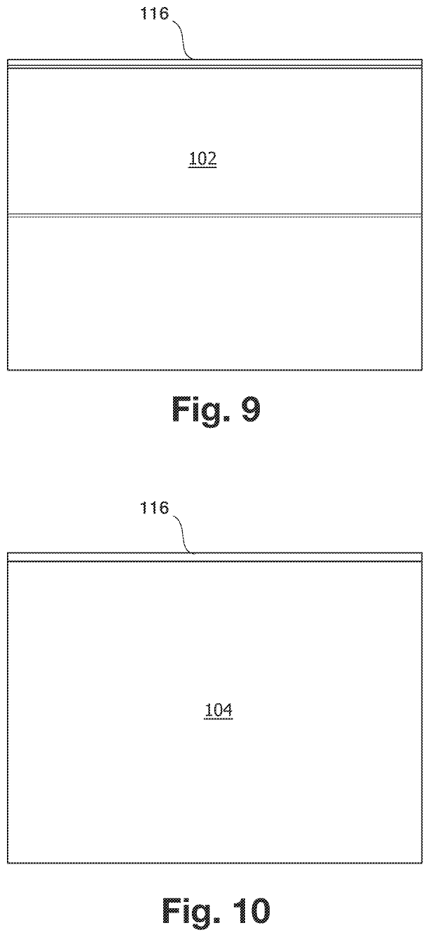

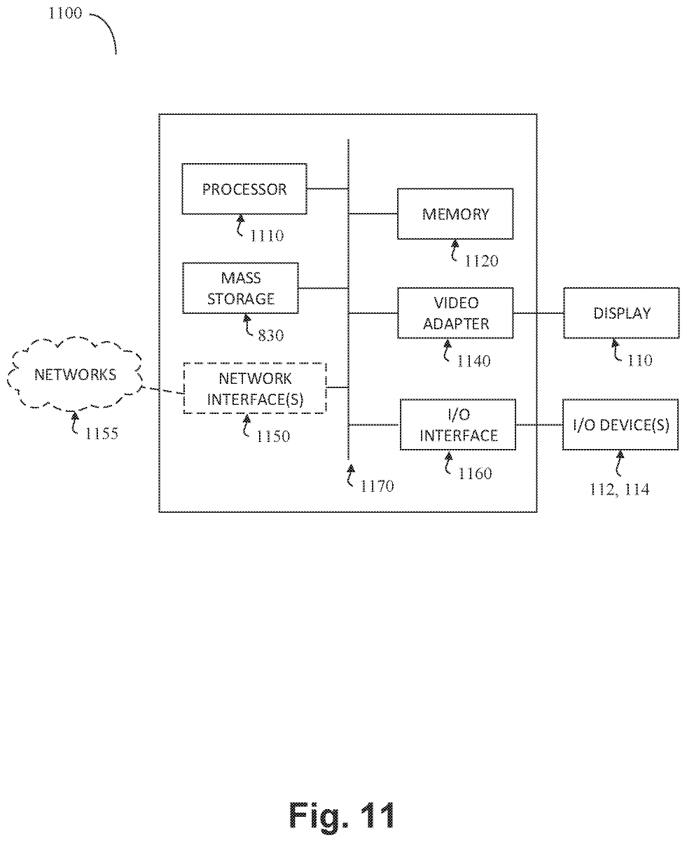

FIG. 9 illustrates a top view of an album in a closed position. FIG. 10 illustrates a bottom view of an album in a closed position.

Sensors may be integrated into the media album 100 such as light sensors, location sensors, position sensor to detect if the front cover 102 is open or a page has been turned, or audio sensors to automatically start or stop the display of digital media under certain conditions. For example, the media album 100 may be configured to play a particular video file on a video display 110 on the inside of the front cover 102 when the light sensor detects that the front cover has been opened.

Media album 100 may include hardware and software to implement wired or wireless networking to enable connections to external video devices, such as televisions, external networks, such as home networks, and the Internet. It also may implement short range networks such as Bluetooth to connect to devices such as cell phones, remote controls, external speakers, external displays, etc.

Hardware and software may be included to control access to the media album. This may require authentication, such as entering a PIN, password, or biometric information, such as a fingerprint scan or face detection, before allowing a user access to copy digital media to the media album 100. or to edit or delete information stored therein.

FIG. 11 is a schematic diagram of an electronic device or module 1100 that may control and manage any or all of operations of a media album 100 described herein, according to different embodiments of the present invention.

As shown, the device includes a processor 1110, such as a Central Processing Unit (CPU) or specialized processors such as a Graphics Processing Unit (GPU) or other such processor unit, memory 1120, non-transitory mass storage 1130, video adapter 1140, I/O interface 1160, and network interface 1150, all of which are communicatively coupled via bi-directional bus 1170. According to certain embodiments, any or all of the depicted elements may be utilized, or only a subset of the elements. Further, the device 1100 may contain multiple instances of certain elements, such as multiple processors, memories, or network interfaces. Also, elements of the hardware device may be directly coupled to other elements without the bi-directional bus. Additionally, or alternatively to a processor and memory, other electronics, such as integrated circuits, may be employed for performing the required logical operations.

The memory 1120 may include any type of non-transitory memory such as static random access memory (SRAM), dynamic random access memory (DRAM), synchronous DRAM (SDRAM), read-only memory (ROM), any combination of such, or the like. The mass storage element 1130 may include any type of non-transitory storage device, such as a solid state drive, USB drive, or any computer program product configured to store data and machine executable program code. Mass storage 1130 may be used to store digital media for playback on video display 110. According to certain embodiments, the memory 1120 or mass storage 1130 may have recorded thereon statements and instructions executable by the processor 1110 for performing any of the aforementioned method operations described above.

Video adapter 1140 is coupled to video display 110 and is configured to read digital media from mass storage 1130 for display on video display 110.

I/O interface 1160 is coupled to sensors included in media album 100 and receives sensor input which may then be evaluated to control digital media playback.

The media album 100 may be powered by a rechargeable battery that may use a USB interface to be recharged or to be powered directly using external power. A USB connector may be placed at the side of top cover 102 or at the back of media album 100, on the top cover 102, bottom cover 104, spine 116, or other suitable position. Any other suitable wired or wireless power interface may also be used to charge or power the media album 100.

Before use, media album 100 may be first be charged by inserting a power cable to a receptacle on media album 100 or placing it on a charging pad. A battery level indicator may be included on a portion of the media album, may be visible on video display 110, or may be visible on an accompanying smart phone app.

Digital media files may be transferred using a wired or wireless connect to internal mass storage 1130. Wired interfaces include an Ethernet connection using an interface such as an RJ-45 connector. Wireless interfaces include the 802.11 family of standards or the Bluetooth family of standards. Digital media files may be copied from a smartphone, a computer, a file server, a cloud computing service, etc.

Once stored on the media album 100, a user may use the user interface to select a video file to be assigned to any or all of the video displays 110 of the media album. For each video file, the user may also define a set of criteria for when the video file is displayed. Criteria can be based on the album being opened so that the video display 110 is visible, on a page being turned, on a schedule, etc. Criteria may be defined for both starting and stopping video playback. Options may also be defined such as audio volume of an audio track of the video file or to play a separate audio file while playing the video file. If digital photos are loaded on the media album and selected for playback as a slideshow, settings for accompanying audio playback may be done as well.

Media album 100 may be paired with or connected to an external monitor or television or to an external audio playback system, or both. A user may specify these external playback and display systems using the user interface.

Media album 100 may utilize a smartphone app as a sole user interface or to supplement a user interface incorporated into the media album itself.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. in particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Although the present invention has been described with reference to specific features and embodiments thereof it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A photo album comprising:
a front cover;
a back cover;
the front cover and the back cover binding a plurality of pages, the plurality of pages configured to have printed photographs displayed thereon;
a video display incorporated into a surface of the front cover, the back cover, or one of the plurality of pages;
an electronic module coupled to the video display, the electronic module including a mass storage storing a video file therein; and
a user interface coupled to the electronic module.

2. The photo album of claim 1 further comprising a sensor coupled to the electronic module, wherein an output of the sensor causes the video file to be displayed on the video display.

3. The photo album of claim 2 wherein the sensor detects when the video display is exposed for viewing.

4. The photo album of claim 1 wherein the video display is disposed on an inner surface of the front cover, the front cover configurable in a position that exposes the video display for viewing.

5. The photo album of claim 1 wherein the video file is displayed on the video display based on a criteria defined through the user interface.

6. The photo album of claim 1 wherein the electronic module includes a wireless network interface and the user interface is accessed using an app.

7. The photo album of claim 1 wherein the electronic module includes a wireless network interface and the video file is displayed on an external video device.

8. The photo album of claim 1 wherein the user interface requires a user to authenticate before allowing access to the user interface.

9. The photo album of claim 1 further comprising a second video display, the user interface allowing the video file to be displayed on the video display or the second video display.

10. The photo album of claim 9 wherein the second video display is disposed on one of the plurality of pages.

11. A method for a photo album to display digital and printed media, the method comprising:
receiving, by the photo album, a video file into a mass storage of the photo album;
receiving, by the photo album, an input from a user interface selecting the digital media file, the input selecting a criteria to start a playback of the video file;
detecting, by an electronic module of the photo album, the criteria; and
starting, by the electronic module, the playback of the video file on a video display incorporated into a surface of a front cover, a back cover, or one of a plurality of pages of the photo album, the electronic module coupled to the video display and the user interface;
wherein, one of the plurality of pages of the photo album are configured to have printed photographs mounted thereon.

12. The method of claim 11, wherein detecting the criteria includes the electronic module receiving a signal from a sensor coupled to the electronic module.

13. The method of claim 12, wherein the sensor detects when the video display is exposed for viewing.

14. The method of claim 10 wherein the video display is disposed on an inner surface of the front cover, the front cover configurable in a position that exposes the video display for viewing.

15. The method of claim 11 further comprising, receiving, by the photo album, a second criteria through the user interface, and stopping the playback of the video file in response to the second criteria being met.

16. The method of claim 11 wherein the electronic module includes a wireless network interface and the user interface is accessed over the wireless network interface.

17. The method of claim 11 wherein the electronic module includes a wireless network interface and the video file is displayed on an external video device using the wireless network interface.

18. The method of claim 11 further comprising, authenticating a user prior to receiving the input over the user interface.

19. The method of claim 11 further comprising starting, by the electronic module, the playback of the video file on a second video display, the second video display being selected through the user interface.

20. The method of claim 19 wherein the second video display is disposed on one of the plurality of pages.
